(19) United States
(12) Patent Application Publication
(10) Pub. No.: US 2015/0039521 A1
(43) Pub. Date: Feb. 5, 2015

(54) RECIPIENT BEHAVIOR TRACKING FOR CUSTOMER SERVICE RESPONSES

(71) Applicant: ORACLE INTERNATIONAL CORPORATION, REDWOOD SHORES, CA (US)

(72) Inventors: AARON SCHUBERT, BOZEMAN, MT (US); CODY WENZEL, BOZEMAN, MT (US); AMY NASH, BELGRADE, MT (US)

(73) Assignee: ORACLE INTERNATIONAL CORPORATION, REDWOOD SHORES, CA (US)

(21) Appl. No.: 13/955,715

(22) Filed: Jul. 31, 2013

(51) Int. Cl. G06Q 30/00

(52) U.S. Cl. CPC G06Q 30/016
USPC 705/304

(57) ABSTRACT

Embodiments of the invention provide systems and methods for managing interactions with a customer in a customer relationship management system. Generally speaking, embodiments of the present invention provide the ability to track customer activity resulting from service related emails or other messages by capturing interaction with the message itself (views/clicks) and the subsequent interaction the user has with the website landing pages. This captured information can then be displayed in a format that allows the agent who sent the response to see the chronological order of various responses sent and the associated activity with each response all of which can be tracked by the individual email addresses associated with the contact.

### BACKGROUND OF THE INVENTION

Embodiments of the present invention relate generally to methods and systems for managing interactions with a customer in a customer relationship management system and more particularly to tracking of behavior of a recipient of a customer service response message.

One type of enterprise application is a Customer Relationship Management (CRM) application. Such an application can provide support for customers of a product or service by allowing those users to make requests for service or otherwise report problems with those products or services. When a request or other report is received, the CRM application typically creates what is commonly referred to as a trouble ticket which is a record of the issue. This trouble ticket is then used by the CRM application as the system attempts to address the request or report, for example by assigning the trouble ticket to an automated process and/or human agent for answering the question or handling the problem.

Agents working on these incidents e.g. calls, emails, etc., can respond in various manners. These responses can include suggestions, links to a knowledge base, content on a customer portal, etc. For example, the agent might send an email, text message, or other response message to the customer with a set of instructions and/or a link to some knowledge base information. In current systems, that is usually the end of that process unless the customer contacts that agent again. So, the incident is considered closed if no further contact is received from that customer after a certain time. That is, the issue is considered resolved by default. There might be, in some cases, a survey sent to the customer to determine satisfactory problem resolution etc. However, these are, for many reasons, unreliable and often do not provide enough insight into the handling of a particular incident. Even in cases where the customer contacts the agent again, it is often difficult, if not impossible, to properly evaluate where the incident resolution stands. For example, there is no reliable way to know for sure if the customer read the agent's message, accessed the knowledge base contents, etc. Hence, there is a need for improved methods and systems for managing interactions with a customer in a customer relationship management system.

### BRIEF SUMMARY OF THE INVENTION

Embodiments of the invention provide systems and methods for tracking of behavior of a recipient of a customer service email or other response message. According to one embodiment, tracking behavior of a recipient of a customer service message can comprise conducting, by a Customer Relationship Management (CRM) system, an exchange between a customer and an agent. A message can be generated related to the exchange. The message can include information identifying the exchange and related incident information saved by the CRM system. The message can be sent to the customer and the behavior of the customer related to the message can be tracked based on the information in the message identifying the exchange.

Tracking the behavior of the customer related to the message can comprise detecting a view of the message by the customer. For example, generating the message can comprise adding an image or a link to the message and detecting the view of the message by the customer can be based on a download of the image or a selection of the link. The detected view can be logged, by the CRM system, in the incident information identified by the information in the message. Tracking the behavior of the customer related to the message can additionally or alternatively comprise detecting selection of content in the message by the customer and logging the selection of the content in the incident information for the incident identified by the information in the message. For example, generating the message can comprise adding a Universal Resource Identifier (URI) to the message and the URI including parameters can identify one or more of the customer, an incident identifier, a session identifier, or a message address. Logging the selection of the content can be based on the parameters of the URI. According to one embodiment, the selected content can be presented to the customer and further interactions with other content by the customer can also be logged.

At some point in time, a contact from a customer can be received by the CRM system. In response, a determination can be made as to whether the contact is related to a new incident or a previous incident. In response to determining the contact is related to a previous incident, an incident identifier for the previous incident can be received, incident information related to an incident identified by the incident identifier can be retrieved, and an agent user interface including the retrieved incident information can be generated and presented to an agent handling the contact from the customer. Additionally or alternatively, a date group report including metrics of totals for messages sent and viewed per a time period can be generated on demand or periodically. The generated date group report can be presented, for example, in a dashboard used by high-level stakeholders overseeing the agents.

### BRIEF DESCRIPTION OF THE DRAWINGS

FIG. 1 is a block diagram illustrating components of an exemplary operating environment in which various embodiments of the present invention may be implemented.

FIG. 2 is a block diagram illustrating an exemplary computer system in which embodiments of the present invention may be implemented.

FIG. 3 is a block diagram illustrating, at a high-level, functional components of a system for tracking of behavior of a recipient of a customer service response message according to one embodiment of the present invention.

FIG. 4 is a flowchart illustrating a process for tracking of behavior of a recipient of a customer service response message according to one embodiment of the present invention.

FIG. 5 is a flowchart illustrating a process for using information related to the tracking of behavior of a recipient of a customer service response message according to one embodiment of the present invention.

FIG. 6 is an illustration of an exemplary user interface for tracking of behavior of a recipient of a customer service response message which includes a representation of an agent incident thread according to one embodiment of the present invention.

FIG. 7 is an illustration of an exemplary user interface for tracking of behavior of a recipient of a customer service response message which includes a representation of agent message details according to one embodiment of the present invention.

FIG. 8 is an illustration of an exemplary user interface for tracking of behavior of a recipient of a customer service response message which includes a representation of agent message details with a drill-down view of additional details according to one embodiment of the present invention.

FIG. 9 is an illustration of an exemplary user interface for tracking of behavior of a recipient of a customer service response message which includes a representation of a message statistics report according to one embodiment of the present invention.

### DETAILED DESCRIPTION OF THE INVENTION

In the following description, for the purposes of explanation, numerous specific details are set forth in order to provide a thorough understanding of various embodiments of the present invention. It will be apparent, however, to one skilled in the art that embodiments of the present invention may be practiced without some of these specific details. In other instances, well-known structures and devices are shown in block diagram form.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the spirit and scope of the invention as set forth in the appended claims.

Specific details are given in the following description to provide a thorough understanding of the embodiments. However, it will be understood by one of ordinary skill in the art that the embodiments may be practiced without these specific details. For example, circuits, systems, networks, processes, and other components may be shown as components in block diagram form in order not to obscure the embodiments in unnecessary detail. In other instances, well-known circuits, processes, algorithms, structures, and techniques may be shown without unnecessary detail in order to avoid obscuring the embodiments.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “machine-readable medium” includes, but is not limited to portable or fixed storage devices, optical storage devices, wireless channels and various other mediums capable of storing, containing or carrying instruction(s) and/or data. A code segment or machine-executable instructions may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium. A processor(s) may perform the necessary tasks.

Embodiments of the invention provide systems and methods for managing interactions with a customer in a customer relationship management system. Generally speaking, embodiments of the present invention provide the ability to track customer activity resulting from service related emails or other messages by capturing interaction with the message itself (views/clicks) and the subsequent interaction the user has with the website landing pages. This captured information (e.g., knowledge base content viewed, ip address, user agent, length of session, follow-up questions submitted, feedback presented on suggested answers, etc.) can then be displayed in a format that allows the agent who sent the response to see the chronological order of various responses sent and the associated activity with each response all of which can be tracked by the individual email addresses associated with the contact. It should be noted that while the description below refers to email messages as one example, embodiments of the present invention should not be considered to be limited to only these types of messages. Rather, various embodiments and different implementation are adaptable to other forms of communications that allow one to provide a link therein including but not limited to Short Message Service (SMS) messages, Multimedia Message Service (MMS) messages, posts to social media or forum boards, instant messages, etc. Various additional details of embodiments of the present invention will be described below with reference to the figures.

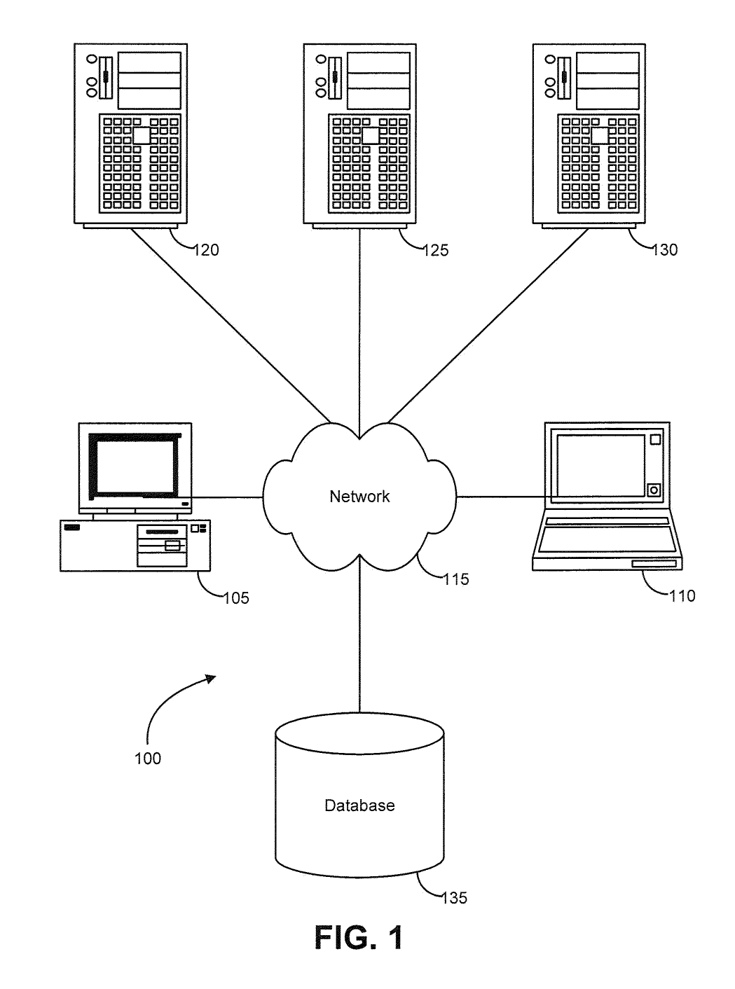

FIG. 1 is a block diagram illustrating components of an exemplary operating environment in which various embodiments of the present invention may be implemented. The system 100 can include one or more user computers 105, 110, which may be used to operate a client, whether a dedicated application, web browser, etc. The user computers 105, 110 can be general purpose personal computers (including, merely by way of example, personal computers and/or laptop computers running various versions of Microsoft Corp.'s Windows and/or Apple Corp.'s Macintosh operating systems) and/or workstation computers running any of a variety of commercially-available UNIX or UNIX-like operating systems (including without limitation, the variety of GNU/Linux operating systems). These user computers 105, 110 may also have any of a variety of applications, including one or more development systems, database client and/or server applications, and web browser applications. Alternatively, the user computers 105, 110 may be any other electronic device, such as a thin-client computer, Internet-enabled mobile telephone, and/or personal digital assistant, capable of communicating via a network (e.g., the network 115 described below) and/or displaying and navigating web pages or other types of electronic documents. Although the exemplary system 100 is shown with two user computers, any number of user computers may be supported.

In some embodiments, the system 100 may also include a network 115. The network may can be any type of network familiar to those skilled in the art that can support data communications using any of a variety of commercially-available protocols, including without limitation TCP/IP, SNA, IPX, AppleTalk, and the like. Merely by way of example, the network 115 maybe a local area network (“LAN”), such as an Ethernet network, a Token-Ring network and/or the like; a wide-area network; a virtual network, including without limitation a virtual private network (“VPN”); the Internet; an intranet; an extranet; a public switched telephone network (“PSTN”); an infra-red network; a wireless network (e.g., a network operating under any of the IEEE 802.11 suite of protocols, the Bluetooth protocol known in the art, and/or any other wireless protocol); and/or any combination of these and/or other networks such as GSM, GPRS, EDGE, UMTS, 3G, 2.5 G, CDMA, CDMA2000, WCDMA, EVDO etc.

The system may also include one or more server computers 120, 125, 130 which can be general purpose computers and/or specialized server computers (including, merely by way of example, PC servers, UNIX servers, mid-range servers, mainframe computers rack-mounted servers, etc.). One or more of the servers (e.g., 130) may be dedicated to running applications, such as a business application, a web server, application server, etc. Such servers may be used to process requests from user computers 105, 110. The applications can also include any number of applications for controlling access to resources of the servers 120, 125, 130.

The web server can be running an operating system including any of those discussed above, as well as any commercially-available server operating systems. The web server can also run any of a variety of server applications and/or mid-tier applications, including HTTP servers, FTP servers, CGI servers, database servers, Java servers, business applications, and the like. The server(s) also may be one or more computers which can be capable of executing programs or scripts in response to the user computers 105, 110. As one example, a server may execute one or more web applications. The web application may be implemented as one or more scripts or programs written in any programming language, such as Java™, C, C# or C++, PHP, and/or any scripting language, such as Perl, Python, or TCL, as well as combinations of any programming/scripting languages. The server(s) may also include database servers, including without limitation those commercially available from Oracle®, Microsoft®, Sybase®, IBM® and the like, which can process requests from database clients running on a user computer 105, 110.

In some embodiments, an application server may create web pages dynamically for displaying on an end-user (client) system. The web pages created by the web application server may be forwarded to a user computer 105 via a web server. Similarly, the web server can receive web page requests and/or input data from a user computer and can forward the web page requests and/or input data to an application and/or a database server. Those skilled in the art will recognize that the functions described with respect to various types of servers may be performed by a single server and/or a plurality of specialized servers, depending on implementation-specific needs and parameters.

The system 100 may also include one or more databases 135. The database(s) 135 may reside in a variety of locations. By way of example, a database 135 may reside on a storage medium local to (and/or resident in) one or more of the computers 105, 110, 115, 125, 130. Alternatively, it may be remote from any or all of the computers 105, 110, 115, 125, 130, and/or in communication (e.g., via the network 120) with one or more of these. In a particular set of embodiments, the database 135 may reside in a storage-area network (“SAN”) familiar to those skilled in the art. Similarly, any necessary files for performing the functions attributed to the computers 105, 110, 115, 125, 130 may be stored locally on the respective computer and/or remotely, as appropriate. In one set of embodiments, the database 135 may be a relational database, such as Oracle 10g, that is adapted to store, update, and retrieve data in response to SQL-formatted commands.

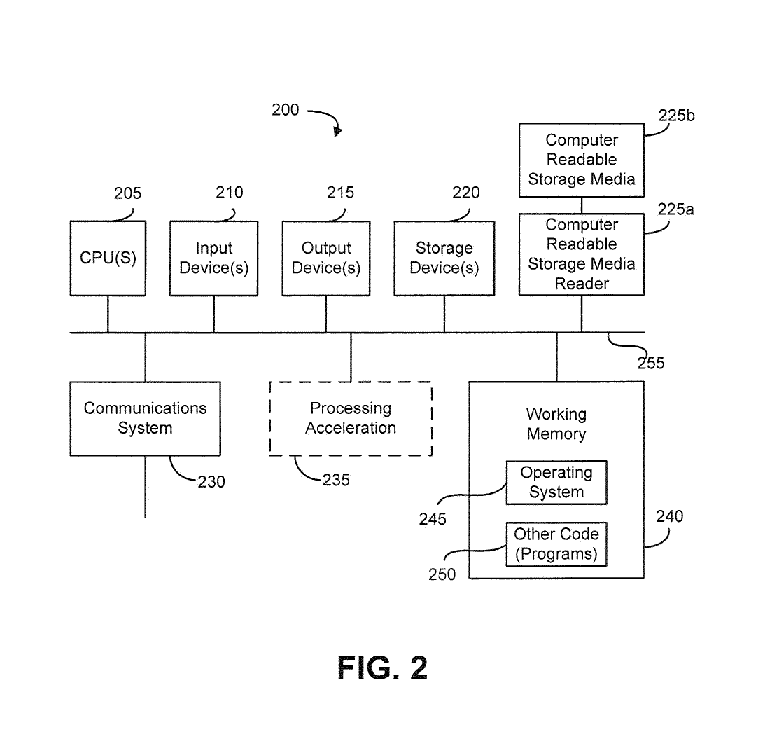

FIG. 2 illustrates an exemplary computer system 200, in which various embodiments of the present invention may be implemented. The system 200 may be used to implement any of the computer systems described above. The computer system 200 is shown comprising hardware elements that may be electrically coupled via a bus 255. The hardware elements may include one or more central processing units (CPUs) 205, one or more input devices 210 (e.g., a mouse, a keyboard, etc.), and one or more output devices 215 (e.g., a display device, a printer, etc.). The computer system 200 may also include one or more storage device 220. By way of example, storage device(s) 220 may be disk drives, optical storage devices, solid-state storage device such as a random access memory (“RAM”) and/or a read-only memory (“ROM”), which can be programmable, flash-updateable and/or the like.

The computer system 200 may additionally include a computer-readable storage media reader 225a, a communications system 230 (e.g., a modem, a network card (wireless or wired), an infra-red communication device, etc.), and working memory 240, which may include RAM and ROM devices as described above. In some embodiments, the computer system 200 may also include a processing acceleration unit 235, which can include a DSP, a special-purpose processor and/or the like.

The computer-readable storage media reader 225a can further be connected to a computer-readable storage medium 225b, together (and, optionally, in combination with storage device(s) 220) comprehensively representing remote, local, fixed, and/or removable storage devices plus storage media for temporarily and/or more permanently containing computer-readable information. The communications system 230 may permit data to be exchanged with the network 220 and/or any other computer described above with respect to the system 200.

The computer system 200 may also comprise software elements, shown as being currently located within a working memory 240, including an operating system 245 and/or other code 250, such as an application program (which may be a client application, web browser, mid-tier application, RDBMS, etc.). It should be appreciated that alternate embodiments of a computer system 200 may have numerous variations from that described above. For example, customized hardware might also be used and/or particular elements might be implemented in hardware, software (including portable software, such as applets), or both. Further, connection to other computing devices such as network input/output devices may be employed. Software of computer system 200 may include code 250 for implementing embodiments of the present invention as described herein.

As introduced above, embodiments of the present invention provide the ability to track customer activity resulting from service related emails or other messages by capturing interaction with the message itself (views/clicks) and the subsequent interaction the user has with the website landing pages provided by a Customer Relationship Management (CRM) system. This captured information (e.g., knowledge base content viewed, ip address, user agent, length of session, follow-up questions submitted, feedback presented on suggested answers, etc.) can then be displayed by the CRM system in a format that allows an agent who sent the message to see the chronological order of various responses sent and the associated activity with each response all of which can be tracked by the individual email addresses associated with the contact.

Previously, there was not a way built into the system to easily provide success metrics on agent responses to customer service inquiries. The best companies could hope for was to get a survey response where the user expresses his or her satisfaction level. This capability to allow an agent to view service response message statistics including message reads, clicks, and subsequent customer portal session information resulting from the clicks is extremely valuable. Embodiments described herein allow that agent to know: whether the end-user opened the message; whether they clicked a link in the message; whether they clicked a link to the knowledge base and then looked at several self-service answers; etc. Embodiments of the present invention also allow companies to evaluate the effectiveness of their agents by analyzing click-through percentage and service resolution. Not only does it provide a way to measure agents but also the effectiveness of the knowledge base articles or even smart assistant (the intelligent auto-suggest of knowledge articles). Embodiments of the present invention also allow companies to learn what kinds of responses drive interaction with their users and can eventually use this information to result in follow-up business with these individuals.

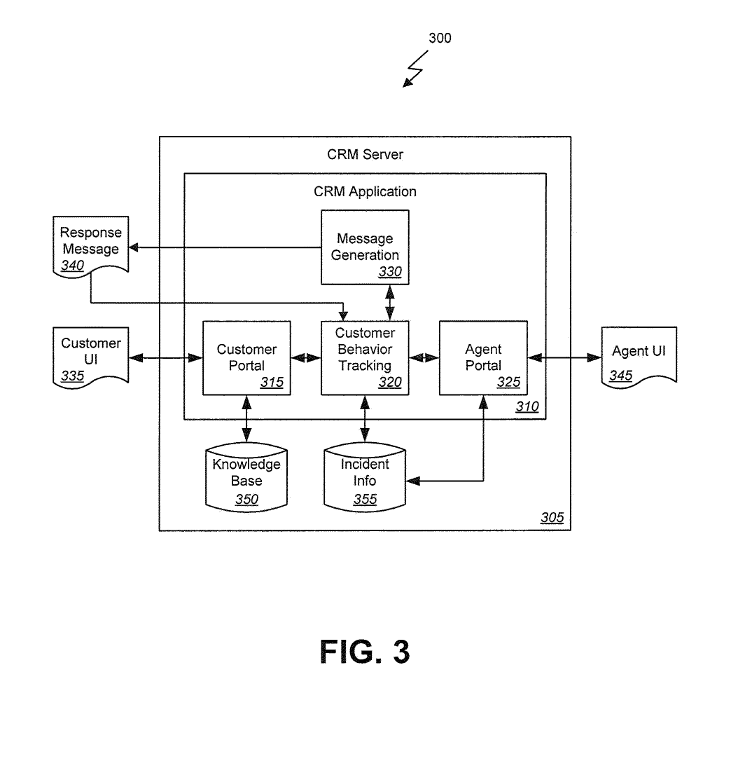

FIG. 3 is a block diagram illustrating, at a high-level, functional components of a system for tracking of behavior of a recipient of a customer service response message according to one embodiment of the present invention. As illustrated here, the system 300 can include a CRM server 305 such as any of the servers or other systems described above. The CRM server 305 can execute a CRM application 310. As known in the art, the CRM system 305 and CRM application 310 can provide support for customers of a product or service by allowing those users to make requests for service. For example, a user may log onto or access the CRM application 310 through a customer user interface 335 such as a web page or other interface provided by a customer portal 315 of the CRM application 305. Additionally or alternatively, the CRM application 310 can receive requests for service through any number of other communication channels, e.g., in the form of a phone call, instant message, email, etc. The CRM application 310 can then route the requests to an automated process and/or a human agent for addressing the request and providing an answer to the question. In many cases, the agent is selected based on the topic of the question or the nature of the problem and a predefined profile of that agent that includes indications of the agent's skills and/or expertise.

Once routed to a human agent, that agent can interact with the CRM application 310 through an agent user interface 345 such as a web page or other interface provided by an agent portal 325 of the CRM application 305. Additionally or alternatively, the CRM application 310 can support interacts between the customer and agent through any number of other communication channels, e.g., in the form of a phone call, instant message, web conference, chat, email, etc. In some cases, during any of these types of exchanges, the agent may decide to send an email 340 or other message to the customer with some information related to the issue being addressed. For example, such information may include contents explaining or related to the issue and possible solutions and/or links to content in a knowledge base 350 of product information, FAQs, help information, etc. maintained by the CRM server 305. In some embodiments, instead of or in addition to an email message, other forms of communications that allow one to provide a link therein including but not limited to Short Message Service (SMS) messages, Multimedia Message Service (MMS) messages, posts to social media or forum boards, instant messages, etc. may be used.

According to one embodiment, when the message 340 is generated by the message generation module 330 of the CRM application 310, tracking information can be added to that message 340 for use by the customer behavior tracking module 320 of the CRM application 310. For example, adding tracking information to the message 340 can comprise add a hidden image such as a sniffer Graphics Interchange Format (GIF) file or other indicator to the message 340 to determine if the message 340 is opened and presumably read. Additionally or alternatively, adding tracking information to the message 340 can comprise creating and adding redirect links to referenced content, e.g., knowledge base 350 content, to be able to track the link clicks. Such redirect links allow the customer behavior tracking module 320 to track the user, the incident, the message recipient who clicked the link, and/or email addresses (if more than one) through parameters of the Universal Resource Identifier (URI). The landing page of the URI can be a page of the customer portal 315 where the session is created. The customer behavior tracking module 320 can log all clicks and other activities as the user views and navigates through the knowledge base 350 through the customer portal 315.

Stated another way, tracking behavior of a recipient of a customer service message 340 can comprise initiating a customer incident, for example, by the customer contacting the CRM system 305 via any of a variety of communications to the CRM system 305 including but not limited to a voice call, an email, a text message, a web conference chat, etc. An exchange can be conducted between the customer and an agent, e.g., via voice call, chat, text messaging, IM, web conference, etc. At some point during or even after this exchange, a message 340 related to the exchange can be generated by the message generation module 330 of the CRM application 310. The message 340 can include information identifying that exchange and which can be used to find related incident information 355 saved by the CRM system 305. The message 340 can be sent from the CRM server 305 to the customer and the behavior of the customer related to the message 340 can be tracked based on the identifying information in the response message 340.

More specifically, tracking the behavior of the customer can comprise detecting, by the customer behavior tracking module 320, a view of the message 340 and logging, by the customer behavior tracking module 320, the view in incident information 355 for the incident identified by the incident identifier in the message 340. For example, generating the message 340 by the message generation module 330 can comprise adding an image to the message 340 and detecting the view of the message by the customer behavior tracking module 320 can be based on a download of the image. In some cases, due to the fact that the recipient may not download the image, embodiments can log a view when a link in the message is clicked and, even if there is no view recorded based on the image download, one can be inferred and added because the user cannot click the link without having viewed the message.

Additionally or alternatively, tracking can comprise detecting, by the customer behavior tracking module 320, selection of content in the message 340 by the customer and logging, by the customer behavior tracking module 320, the selection of the content in incident information 355 for the incident identified by the incident identifier in the message 340. For example, generating the message 340 can comprise adding, by the message generation module 330 a URI to the message 340. The URI can comprise a redirect link to content of the knowledge base 350 or elsewhere and can include parameters identifying one or more of the customer, the incident identifier, the session identifier, or an email address to which the message 340 is being sent. The subsequent selection of the content, i.e., based on selection of the URI, can be logged by the customer behavior tracking module 320 based on the parameters of the URI. Further, the selected content can be presented to the customer, e.g., through the customer portal 315 and customer user interface 335, and further interactions with other content by the customer detected by the customer behavior tracking module 320. The detected further interactions with the other content can also be logged by the customer behavior tracking module 320 in incident information 355 for the incident identified by the incident identifier in the message 340.

Then, using information related to the tracking of behavior of a recipient of a customer service response message can begin with the CRM application 310 receiving a subsequent contact from a customer. The contact can comprise any of a variety of communications to the CRM system 305 including but not limited to a voice call, an email, a text message, a web conference chat, etc. A determination can be made by the CRM application 310 as to whether the contact is related to a new incident or a previous incident. For example, this determination can be based on the customer indicating in the communication that this communication is related to a prior incident or is a new incident. In response to determining the contact is related to a previous incident, an incident identifier for the previous incident can be received and incident information 355 related to an incident identified by the incident identifier can be retrieved. An agent user interface 345 can be generated that includes the retrieved incident information and the interface can be presented to an agent handling the contact from the customer. It should be noted that when the user contacts the system again it is quite possible that there are multiple thread and/or session identifiers that correspond to this same incident. If there have been multiple exchanges with the same agent it is possible that having clicked through in various messages that the user has multiple customer portal sessions which tie back to the same incident but tie back to independent message responses.

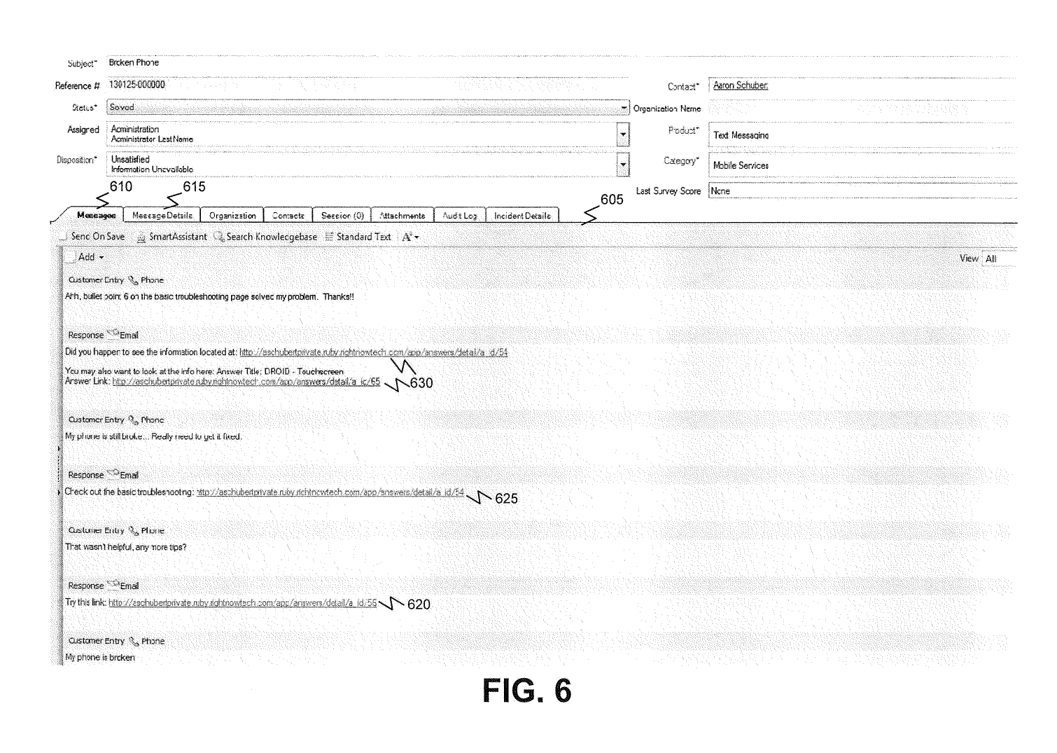

Generally speaking, the customer behavior tracking module 320 can track the agent, other content in knowledge base 350 viewed by the customer, rating of usefulness of that content from the user, etc. This information can be used in reports displayed on a workspace that the agent is using. So the agent can view, through the agent user interface 345 customer activities that resulted from the last email and other communications, emails, etc. According to one embodiment, this information can be presented in chronological order with drilldown capabilities. So, the agent can tell, for example, if content sent to the customer was not helpful or if customer did not view it etc. Additional details of examples of such agent interfaces 345 will be described below with reference to FIGS. 6-9.

Based on the functions of the message generation module 330, the customer behavior tracking module 320, and other elements of the CRM system 305 as described above, other feature and functions can be implemented and added to the system 300. For example, since message sends can be logged, calculation of message view percentage and link click percentage can be made which may in turn be used to determine agent effectiveness. A variety of other metrics can additionally or alternatively be tracked including but not limited to tracking behavior of users from link landing pages, tracking session length, tracking feedback given on suggested answers, tracking follow-up inquiries and total cost resolution, and/or tracking the user agent used in landing pages which in turn can be a way to see if people are checking their email on mobile devices or on other devices.

The different tracked and calculated metrics can be made available through the agent portal 325 and agent user interface 345 to allow agents access directly on the service request itself so they can see the content that has been viewed by the user as to avoid steering them toward something they have already seen. This information also allows agents to see how effective the user thought each answer was. This further allows for mining real-time customer feedback as opposed to sending a survey a week later. They are not asked to remember the experience, but rather, they are judging as they go.

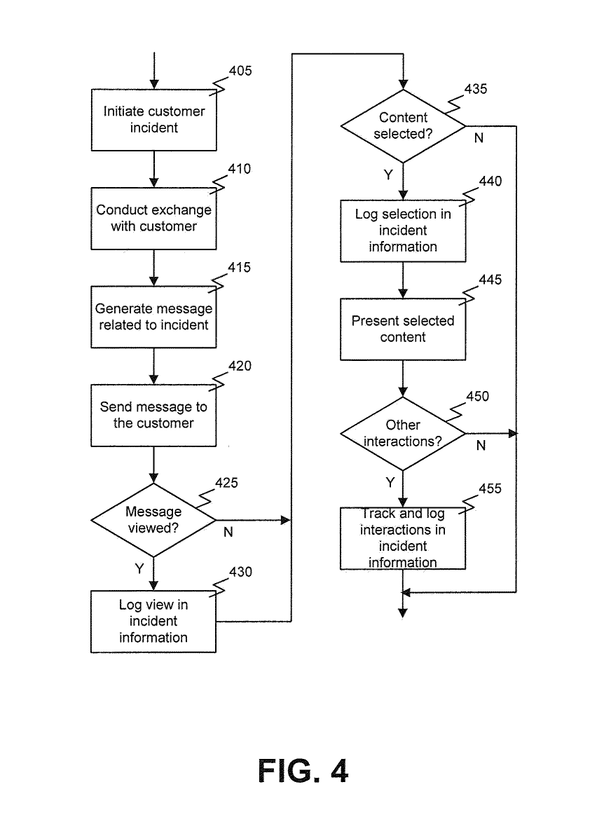

FIG. 4 is a flowchart illustrating a process for tracking of behavior of a recipient of a customer service response message according to one embodiment of the present invention. As illustrated in this example, tracking behavior of a recipient of a customer service message can comprise initiating 405 a customer incident, for example, by the customer contacting the CRM system via any of a variety of communications to the CRM system including but not limited to a voice call, an email, a text message, a web conference chat, etc. An exchange can be conducted 410 between the customer and an agent, e.g., via voice call, chat, text messaging, IM, web conference, etc. At some point during or even after this exchange, a message related to the exchange can be generated 415. The message can include information identifying that exchange and which can be used to find related incident information saved by the system. The message can be sent 420 to the customer and the behavior of the customer related to the message can be tracked 425-450 based on the identifying information in the response message. For example, this identifying information can include, but is not limited to, thread identifier encoded in a URI in the message and which can be used to relate the message to the incident or incident identifier to which the message is related. Additionally, in some cases, the information may include a session identifier. For example, if the user has clicked a link in this or a previous message, a session can be initiated during which, for example, the user may browse the knowledge base or perform other actions. This session identifier, if available and used, can be used to identify the thread from which that session was initiated and the thread identifier can in turn be used to identify the incident to which the thread and session relate.

Tracking actions of the recipient of the message can comprise detecting 425 a view of the message by the customer and logging 430 the view in incident information for the incident identified by the incident identifier in the message. For example, generating 415 the message can comprise adding an image to the message and detecting 425 the view of the message by the customer can be based on a download of the image or inferred from a click on a link within the message. Additionally or alternatively, tracking can comprise detecting 435 selection of content in the message by the customer and logging 440 the selection of the content in incident information for the incident identified by the incident identifier in the message. For example, generating 415 the message can comprise adding a Universal Resource Identifier (URI) to the message, the URI including parameters identifying one or more of the customer, the incident identifier, the session identifier, or an email address. The selection of the content can be logged 440 based on the parameters of the URI. Further, the selected content can be presented 445 to the customer and further interactions with other content by the customer detecting 450. The detected further interactions with the other content can also be logged 455 in incident information for the incident identified by the incident identifier in the message. For example, information collected about these further interactions can include but is not limited to the time spent on a page or in the portal itself, the agent involved, IP address of the user, user feedback posted on any of the answers, any chats that may have been kicked off, subsequent follow-up emails, etc.

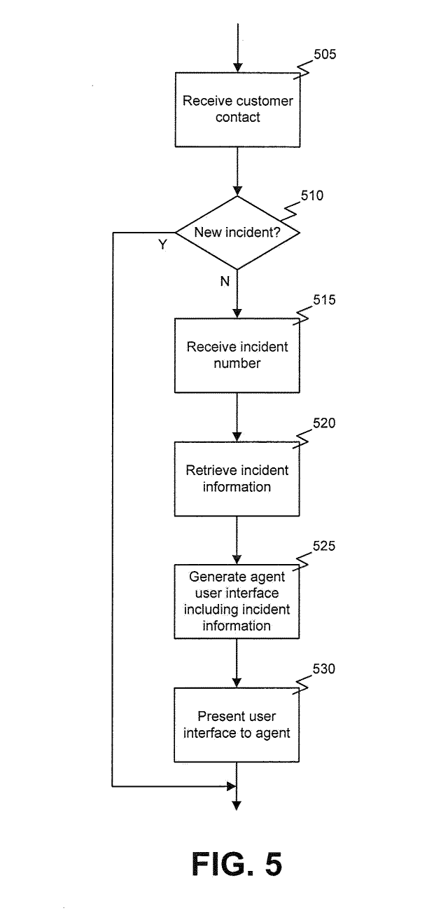

FIG. 5 is a flowchart illustrating a process for using information related to the tracking of behavior of a recipient of a customer service response message according to one embodiment of the present invention. As illustrated in this example, using information related to the tracking of behavior of a recipient of a customer service response message can begin with receiving 505 a contact from a customer. The contact can comprise any of a variety of communications to the CRM system including but not limited to a voice call, an email, a text message, a web conference chat, etc. A determination 510 can be made as to whether the contact is related to a new incident or a previous incident. For example, this determination can be based on the customer indicating in the communication that this communication is related to a prior incident or is a new incident. In response to determining 510 the contact is related to a previous incident, an incident identifier for the previous incident can be received 515 and incident information related to an incident identified by the incident identifier can be retrieved 520. An agent user interface can be generated 525 that includes the retrieved incident information and the interface can be presented 530 to an agent handling the contact from the customer.

The user interface presented 530 to the agent can include a number of different views of the incident information and the information related to tracking of user responses and behavior. Some exemplary views of such interfaces will be described below with reference for FIGS. 6-9. However, it should be noted that the exemplary interfaces described below are offered for illustrative purposes and should not be considered limiting. Rather, numerous variations are contemplated, depending upon the exact implementation, and are also considered to be within the scope of the present invention.

FIG. 6 is an illustration of an exemplary user interface for tracking of behavior of a recipient of a customer service response message which includes a representation of an agent incident thread according to one embodiment of the present invention. More specifically, this example illustrates an example of a portion of a page that can be presented to an agent and that includes a set of customizable tabs 610 and 615. According to one embodiment, this page can be displayed to the agent directly in the same workspace used to respond to the service request.

In this example, the “Messages” tab 610 is selected. With this tab 610 selected, a list 605 of messages can be displayed. According to one embodiment, the entries in this list 605 can be presented in reverse chronological order and can include entries representing messages by the customer and entries representing messages by the agent. The reverse chronological order shows the transactions related to each individual response sent to the customer (rolls up by response). As illustrated in this example, the customer started with a message stating “My phone is broken.” Message 620 indicates an agent attempt to provide a link to an answer that may be helpful. With message 625 the agent provides a link to a second answer. With message 630 the agent realizes from the message details that the customer never clicked through on the last provided answer and chooses to call back instead. So, the agent may verbally offer the same content and perhaps with another possibly helpful solution.

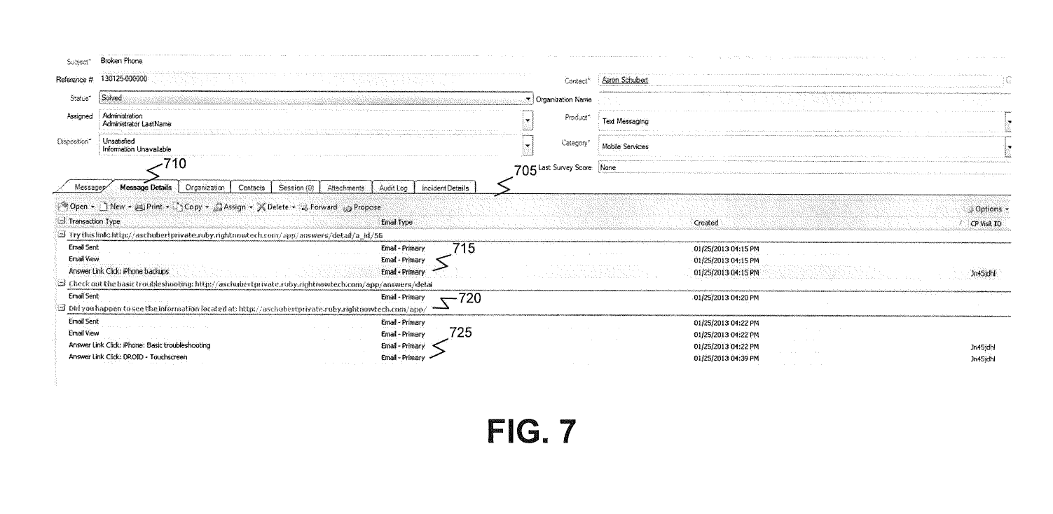

FIG. 7 is an illustration of an exemplary user interface for tracking of behavior of a recipient of a customer service response message which includes a representation of agent message details according to one embodiment of the present invention. In this example, the message details tab 710 has been selected. With this tab 710 selected, a list 705 of messages and additional details for those messages can be displayed. For example and as illustrated here, message 715 indicates that the contact did follow the link provided in the first message while message 720 indicates that the contact did not click the link provided in the second message and message 725 indicates that the contact clicked both links provided in the third message. It should be noted that, while shown in chronological order here, the display may be configurable/selectable and a different presentation may be made. For example in another case, the messages may be arranged in reverse chronological order as in the example of the “Messages” tab display described above with reference to FIG. 6.

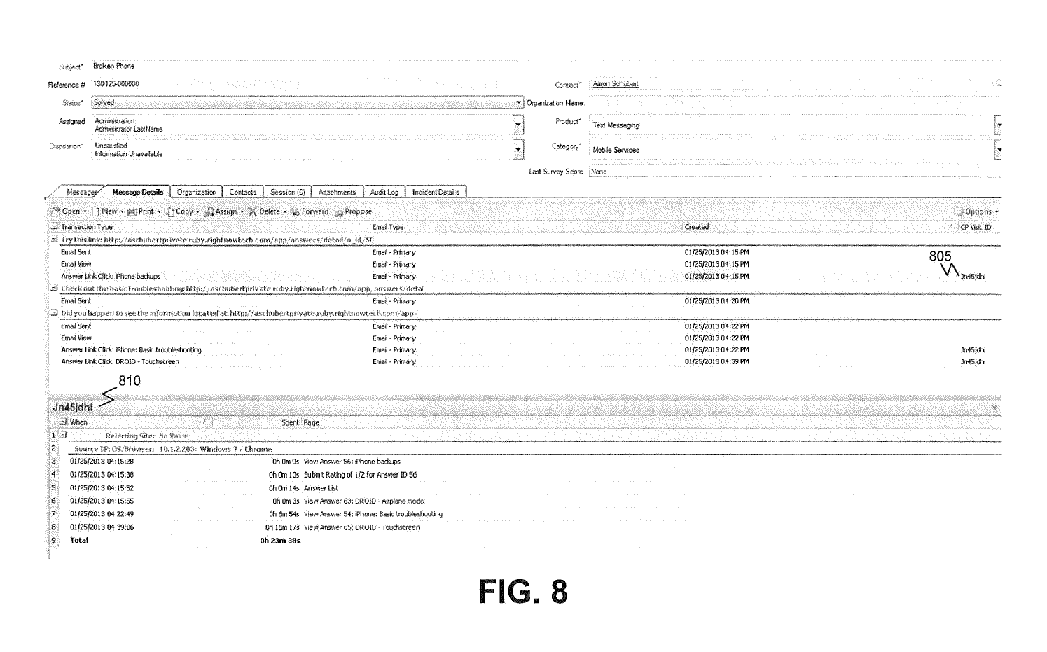

FIG. 8 is an illustration of an exemplary user interface for tracking of behavior of a recipient of a customer service response message which includes a representation of agent message details with a drill-down view of additional details according to one embodiment of the present invention. This example illustrates the page with the “Message Details” tab selected as described above. In this view, the agent can select one of the messages to drill down into greater details on that message. For example, the agent can click or otherwise select the “CP Visit ID” link 805 in the far right-hand column. In response, a list 810 of details for that selected message can be presented. This list 810 can show, for example, customer behavior that occurred following the link click. As illustrated in this example, the customer submitted a rating for the Answer, viewed a list of Answers, and then viewed a couple of other answers as well. In other instances, this list 810 could capture much more such as starting a chat, creating a subsequent service ticket, etc.

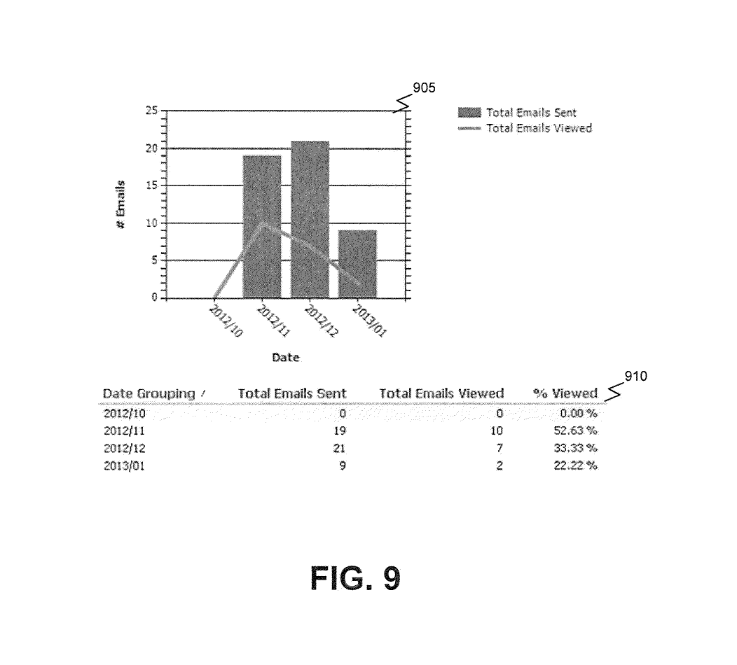

FIG. 9 is an illustration of an exemplary user interface for tracking of behavior of a recipient of a customer service response message which includes a representation of a message statistics report according to one embodiment of the present invention. More specifically, this example illustrates a simple date group report, including a table 910 of metrics and corresponding chart 905, showing totals for message sent/viewed per month. This report could be presented in a number of different ways through the agent user interface. For example, the report may be presented in a dashboard used by high-level stakeholders overseeing the agents. In some cases, the report could be expanded to show other transactions such as answer link clicks or other trackable link clicks. In some cases, the report could be run on a per-agent basis which would provide a view of which agents are getting the most click-throughs on cross-sale/up-sale links. Additionally or alternatively, the report could be run based on aspects of the service ticket such as for certain products. In yet other instances, the report could be based on the individuals receiving the messages, thus providing demographic information such as the click through percentage for everyone who lives in geographic area or based on other demographics.

In use, the tracking information generated by embodiments of the present invention can be used to provide valuable insights into customer interactions with the CRM system and/or the agents. For example, this information can be used as a basis for determining effectiveness of the knowledge base by learning from user interactions post link click. For example, if users clicking a specific knowledge base item are never finished at that point then that item should be looked at to see why it is not useful. In another example, the tracking information can be used as a basis for tracking the agent used by the user and determining effectiveness of the agent by calculating the percentage of time that the user clicks the link and finds their solution. The tracking information can additionally or alternatively be used to build up statistics allowing one to know what type of clients (e.g., how many of the interactions are on mobile devices etc.) are in play. The tracking information can also help to increase agent efficiency by providing them insight into user behavior in an easily digestible format. Additionally or alternatively, the tracking information can be used to capture a customer lifecycle and provide an ability of high level stakeholders to see the overall health of a call center by seeing how many of the agent delivered emails result in the links being clicked and users interacting with the knowledge base.

In the foregoing description, for the purposes of illustration, methods were described in a particular order. It should be appreciated that in alternate embodiments, the methods may be performed in a different order than that described. It should also be appreciated that the methods described above may be performed by hardware components or may be embodied in sequences of machine-executable instructions, which may be used to cause a machine, such as a general-purpose or special-purpose processor or logic circuits programmed with the instructions to perform the methods. These machine-executable instructions may be stored on one or more machine readable mediums, such as CD-ROMs or other type of optical disks, floppy diskettes, ROMs, RAMs, EPROMs, EEPROMs, magnetic or optical cards, flash memory, or other types of machine-readable mediums suitable for storing electronic instructions. Alternatively, the methods may be performed by a combination of hardware and software.

While illustrative and presently preferred embodiments of the invention have been described in detail herein, it is to be understood that the inventive concepts may be otherwise variously embodied and employed, and that the appended claims are intended to be construed to include such variations, except as limited by the prior art.

What is claimed is:

1. A method for tracking behavior of a recipient of a customer service message, the method comprising:
conducting, by a Customer Relationship Management (CRM) system, an exchange between a customer and an agent;
generating, by the CRM system, a message related to the exchange, the message including information identifying the exchange and related incident information saved by the CRM system;
sending, by the CRM system, the message to the customer; and
tracking, by the CRM system, the behavior of the customer related to the message based on the information in the message identifying the exchange.

2. The method of claim 1, wherein tracking comprises:
detecting, by the CRM system, a view of the message by the customer; and
logging, by the CRM system, the view in the incident information for the information in the message.

3. The method of claim 2, wherein generating the message comprises adding an image or a link to the message and wherein detecting the view of the message by the customer is based on a download of the image or a selection of the link.

4. The method of claim 1, wherein tracking comprises:
detecting selection of content in the message by the customer; and
logging the selection of the content in the incident information for the incident identified by the information in the message.

5. The method of claim 4, wherein generating the message comprises adding a Universal Resource Identifier (URI) to the message, the URI including parameters identifying one or more of the customer, an incident identifier, a session identifier, or an message address, and wherein logging the selection of the content is based on the parameters of the URI.

6. The method of claim 5, further comprising:
presenting, by the CRM system, the selected content to the customer; and
detecting, by the CRM system, further interactions with other content by the customer.

7. The method of claim 6, further comprising logging, by the CRM system, the detected further interactions with the other content in the incident information for the incident identified by the information in the message.

8. The method of claim 1, further comprising:
receiving, by the CRM system, a contact from a customer;
determining, by the CRM system, whether the contact is related to a new incident or a previous incident;
in response to determining the contact is related to a previous incident, receiving, by the CRM system, an incident identifier for the previous incident, retrieving, by the CRM system, incident information related to an incident identified by the incident identifier, generating, by the CRM system, an agent user interface including the retrieved incident information, and presenting, by the CRM system, the generated agent user interface to an agent handling the contact from the customer.

9. The method of claim 1, further comprising:
generating, by the CRM system, a date group report including metrics of totals for messages sent and viewed per a time period; and
presented, by the CRM system, the generated date group report in a dashboard used by high-level stakeholders overseeing the agents.

10. A system comprising:
a processor; and
a memory coupled with and readable by the processor and storing therein a set of instructions which, when executed by the processor, cause the processor to track behavior of a recipient of a customer service message by:
conducting, by a Customer Relationship Management (CRM) system, an exchange between a customer and an agent;
generating, by the CRM system, a message related to the exchange, the message including information identifying the exchange and related incident information saved by the CRM system;
sending, by the CRM system, the message to the customer; and
tracking, by the CRM system, the behavior of the customer related to the message based on the information in the message identifying the exchange.

11. The system of claim 10, wherein tracking comprises:
detecting, by the CRM system, a view of the message by the customer; and
logging, by the CRM system, the view in the incident information for the information in the message.

12. The system of claim 11, wherein generating the message comprises adding an image or a link to the message and wherein detecting the view of the message by the customer is based on a download of the image or a selection of the link.

13. The system of claim 10, wherein tracking comprises:
detecting selection of content in the message by the customer; and
logging the selection of the content in the incident information for the incident identified by the information in the message.

14. The system of claim 13, wherein generating the message comprises adding a Universal Resource Identifier (URI) to the message, the URI including parameters identifying one or more of the customer, an incident identifier, a session identifier, or an message address, and wherein logging the selection of the content is based on the parameters of the URI.

15. The system of claim 14, further comprising:
presenting, by the CRM system, the selected content to the customer; and
detecting, by the CRM system, further interactions with other content by the customer.

16. The system of claim 15, further comprising logging, by the CRM system, the detected further interactions with the other content in the incident information for the incident identified by the information in the message.

17. The system of claim 10, further comprising:
receiving, by the CRM system, a contact from a customer;
determining, by the CRM system, whether the contact is related to a new incident or a previous incident;
in response to determining the contact is related to a previous incident, receiving, by the CRM system, an incident identifier for the previous incident, retrieving, by the CRM system, incident information related to an incident identified by the incident identifier, generating, by the CRM system, an agent user interface including the retrieved incident information, and presenting, by the CRM system, the generated agent user interface to an agent handling the contact from the customer.

18. The system of claim 10, further comprising:
generating, by the CRM system, a date group report including metrics of totals for messages sent and viewed per a time period; and
presented, by the CRM system, the generated date group report in a dashboard used by high-level stakeholders overseeing the agents.

19. A computer-readable memory comprising a set of instructions stored therein which, when executed by a processor, cause the processor to track behavior of a recipient of a customer service message by:
conducting, by a Customer Relationship Management (CRM) system, an exchange between a customer and an agent;
generating, by the CRM system, a message related to the exchange, the message including information identifying the exchange and related incident information saved by the CRM system;
sending, by the CRM system, the message to the customer; and
tracking, by the CRM system, the behavior of the customer related to the message based on the information in the message identifying the exchange.

20. The computer-readable memory of claim 19, wherein tracking comprises:
detecting, by the CRM system, a view of the message by the customer, wherein generating the message comprises adding an image or a link to the message and wherein detecting the view of the message by the customer is based on a download of the image or a selection of the link; and
logging, by the CRM system, the view in the incident information for the information in the message, and wherein tracking comprises detecting selection of content in the message by the customer and logging the selection of the content in the incident information for the incident identified by the information in the message.
